(19) United States
(12) Patent Application Publication
(10) Pub. No.: US 2026/0166510 A1
(43) Pub. Date: Jun. 18, 2026

(54) ENCAPSULATION OF ORGANIC PEROXIDES WITH POLYUREA SHELLS

(71) Applicant: Arkema Inc., King of Prussia, PA (US)

(72) Inventors: Krysten R. MINNICI, King of Prussia, PA (US); Evan CROCKER, King of Prussia, PA (US); Christian Guy BECKER, King of Prussia, PA (US)

(21) Appl. No.: 19/124,955

(22) PCT Filed: Oct. 26, 2023
(86) PCT No.: PCT/US2023/077872

§ 371 Date: Apr. 28, 2025

Related U.S. Application Data
(60) Provisional application No. 63/420,108, filed on Oct. 28, 2022.

(51) Int. Cl. B01J 13/16; B01J 13/20; C08G 18/08; C08G 71/02; C08K 5/14; C08K 9/10

(52) U.S. Cl. CPC B01J 13/16; B01J 13/206; C08G 18/0852; C08G 71/02; C08K 5/14; C08K 9/10

(57) ABSTRACT

Encapsulated liquid organic peroxide particles with a polyurea shell for use in a variety of applications. A method of encapsulating a liquid organic peroxide including a polymerization reaction between an aqueous mixture of amines and an organic solution that includes at least one isocyanate.

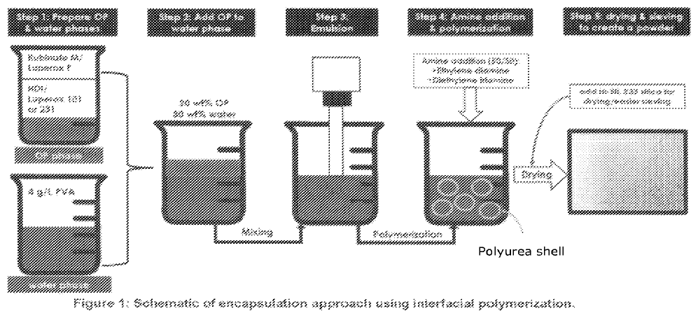

### TECHNICAL FIELD

The present disclosure relates to encapsulated liquid peroxide particles encapsulated with polyurea shells, and products made using those encapsulated liquid peroxide particles. The present disclosure further relates to methods for encapsulating organic liquid peroxides with polyurea shells.

### BACKGROUND

Organic peroxides (“OPs”) are used in a variety of applications including for example, polymer initiation, polymer modification, rubber crosslinking, and composites curing. Examples of organic peroxide applications include production of polymers such as styrene, polypropylene vis-breaking, and crosslinking in rubbers used in automotive, composite boats, truck bodies, and pultruded articles. Radicals are produced by the natural thermal degradation of OPs at a given temperature or through chemical promotion. Degradation of OPs to radicals creates heat and byproducts that can become problematic if uncontrolled. Encapsulation provides several advantages in the use of organic peroxides.

For example, encapsulation of liquid organic peroxides can change their form to a solid, thereby providing improved handling and/or safety in certain applications. Encapsulating an organic peroxide can protect it from other components of a formulation, thereby improving formulation stability and/or providing on-demand cure through controlled release of the encapsulate. This can potentially allow for use in promoted systems in previously inaccessible applications such as pultrusion or polymer initiation, in turn reducing the need for more hazardous low temperature storage peroxides. Encapsulation can also protect organic peroxides from inadvertent promotion through contamination.

A variety of techniques have been used or proposed for encapsulation of peroxides, among which one method has been the deposition of an enclosing film by coacervation. Other procedures have involved polymerizing a substance contained in droplets or in a surrounding continuous liquid phase, so as to deposit the resulting polymer (from the droplets or the liquid phase) at the surface of such droplets. Another method involves the shooting of droplets through a falling film of liquid capsule-wall material, which then solidifies around the individual droplets.

WO0015694A2 describes the use of encapsulated organic peroxides for the curing of resins. Though the organic peroxides described include solid and liquid organic peroxides, the encapsulation procedure disclosed therein focuses primarily on adsorption of the organic peroxide onto a substrate using an almond shell encapsulation approach or encapsulation using ultrasound.

U.S. Pat. No. 3,577,515 describes methods and techniques for preparing crosslinked microcapsule walls using a process wherein compounds such as diacid chlorides, bischloroformates, disulfonyl chlorides, polyacid chlorides, polychloroformates, diisocyanates, polyisocyanates, polysulfonyl chlorides, phosgene, or other organic intermediates are encapsulated by interfacial condensation. The encapsulation processes are used to encapsulate liquid organic peroxides using sebacoyl chloride.

U.S. Pat. No. 4,102,800 is directed to alkylated phenol sulfide contained within microcapsules, in which the capsule wall is a crosslinked polyamide, polyurea, or polyamide-polyurea resin.

US Pub 2019/060245 describes processes for encapsulating solid organic peroxides involving the formation of micelles of sodium or potassium salts of fatty acids around solid peroxide particles.

Accordingly, there remains a need for an effective, simple, practical, convenient, and readily controlled encapsulation process for liquid organic peroxides.

### SUMMARY

Embodiments of the present disclosure relate to encapsulated liquid organic peroxide particles encapsulated with a polyurea shell, processes for encapsulating the liquid organic peroxides with a polyurea shell, and compositions or materials made by or using such encapsulated liquid organic peroxides.

The encapsulated liquid organic peroxide particles may comprise, consist essentially of, or consist of, a liquid organic peroxide encapsulated by a polyurea shell, wherein the liquid organic peroxide contributes from about 70 wt % to about 95 wt % towards the overall weight of the encapsulated liquid organic peroxide (i.e., the total weight of the encapsulated shell and the liquid organic peroxide therein). The resulting encapsulated liquid organic peroxide particles may be in emulsion form or in the form of solid particles, including for example, powders, which may be free-flowing.

In some embodiments, the encapsulated liquid organic peroxide particles may comprise a drying agent, such as silica or the like.

In some embodiments, the encapsulated liquid organic peroxide particles comprise one or more surfactants, such as polyvinylpyrrolidone, polyvinyl alcohol, combinations thereof, and the like.

In some embodiments, the encapsulated liquid organic peroxide particles comprise a liquid organic peroxide encapsulated by a polyurea shell, wherein the polyurea shell is formed by polymerization between a preformed aqueous mixture of amines and an organic solution comprising at least one isocyanate.

The encapsulated liquid peroxide particles can be produced via polymerization, the method comprising the steps of:
preparing an organic phase solution comprising at least one isocyanate dispersed in a liquid organic peroxide,
preparing a water phase solution comprising at least one surfactant,
mixing the organic phase solution with the water phase solution to form an emulsion,
adding an aqueous solution comprising at least one amine, and preferably two amines in mixture form, to the emulsion to initiate polymerization,
mixing the aqueous solution and the emulsion for a period of time until a solution comprising encapsulated liquid peroxide particles is produced,
isolating, and optionally drying the encapsulated liquid peroxide particles to form solid particles, preferably containing less than 10% water and/or organic solvent(s), or less than 5% water and/or organic solvent(s), or less than 2% water and/or organic solvents, or less than 1% water and/or organic solvent, or less than 0.5% water and/or organic solvents.

The encapsulated liquid organic peroxide particles can be used to create compositions or products useful for crosslinking of rubber and/or elastomers, polymer initiation, rheology control, scorch reduction, composites such as for example polyester resins, and 3D printing applications. For example, the encapsulated liquid organic peroxide particles could be used as a cross-linking agent for silicone, EPDM, polyethylene, chlorinated polyethylene, fluoroelastomers, and the like and may improve the retained amount of cure overtime when compared to neat (i.e., unencapsulated) organic peroxides.

### BRIEF DESCRIPTION OF FIGURE

The FIGURE depicts an embodiment of the synthesis of the encapsulated liquid organic peroxide particles of the invention.

### DETAILED DESCRIPTION

One aspect of the present disclosure relates to encapsulated liquid organic peroxide particles comprising a liquid peroxide encapsulated by a polyurea shell, and optionally a drying agent. In one embodiment, the liquid organic peroxide contributes from about 70 wt % to about 95 wt % towards the overall weight of the encapsulated liquid organic peroxide particle.

The encapsulated liquid organic peroxide particles may have a core-shell structure, whereby the liquid organic peroxide particles provide a core surrounded at least partially or fully by a polyurea shell.

The liquid organic peroxide encapsulated by the polyurea shell includes any liquid organic peroxide, including but not limited to liquid organic peroxide(s) belonging to the family of, or selected from the group consisting of, aliphatic and aromatic diacyl peroxides, dialkyl peroxides, peroxyketal peroxides, peroxyesters, monoperoxycarbonates, peroxydicarbonates, and hydroperoxide peroxides and/or combinations/mixtures thereof; preferably including but not limited to those which are liquid at room temperature (i.e., liquid at 25° C.) including mixtures thereof. The peroxydicarbonate, perester, dialkyl and hydroperoxide families are preferred, with peroxydicarbonates and peresters being more preferred. Examples of diacyl peroxides include decanoyl peroxide, myristoyl peroxide, di-(3,5,5-trimethylhexanoyl) peroxide, o-methylbenzoyl peroxide, o-methoxybenzoyl peroxide, o-ethoxy benzoyl peroxide, o-chlorobenzoyl peroxide and 2,4-dichlorobenzoyl peroxide. Examples of dialkyl peroxides include di(t-butyl) peroxide, 2,5-dimethyl-2,5-di-(t-butylperoxy)hexane. Examples of peroxyketals include 1,1-di(t-amylperoxy)-cyclohexane, 1,1-di(t-butylperoxy)-cyclohexane, 1,1-di(t-butylperoxy)-3,3,5-trimethylcyclohexane. Examples of peroxyesters include t-butyl peroxypivalate, t-butyl peroxyneodecanoate, t-butyl peroxy 2-ethylhexanoate, t-amyl peroxy 2-ethylhexanoate, t-amyl peroxypivalate, and t-butyl peroxybenzoate. Examples of monoperoxycarbonates include: OO-(t-butyl) O-(2-ethylhexyl) monoperoxycarbonate and OO-(t-amyl) O-(2-ethylhexyl) monoperoxycarbonate. Examples of hydroperoxides include t-butyl hydroperoxide, t-amyl hydroperoxide, cumene hydroperoxide. Examples of peroxydicarbonates include di(sec-butyl) peroxydicarbonate, di(2-ethylhexyl) peroxydicarbonate, di(n-propyl) peroxydicarbonate.

In exemplary embodiments the liquid organic peroxide may be combined with other organic peroxides that are a solid a room temperature. In exemplary embodiments, the liquid organic peroxide particles include at least 1 wt %, 2 wt %, 5 wt %, 10 wt %, 15 wt %, 20 wt %, 25 wt %, 30 wt %, 40 wt %, 50 wt %, 60 wt %, 70 wt %, 80 wt %, 90 wt %, up to 99 wt %, of other organic peroxides and mixtures thereof that are solid at room temperature. In exemplary embodiments, the liquid organic peroxide particles include less than 50 wt %, 40 wt %, 30 wt %, 20 wt %, 10 wt %, 5 wt %, 2 wt %, or 1 wt % of other organic peroxides and mixtures thereof that are solid at room temperature.

In exemplary embodiments, the encapsulated liquid organic peroxide particles do not contain ketone peroxides, benzoyl peroxide, lauryl peroxide, t-butyl peroxymalic acid and/or combinations thereof. In exemplary embodiments, the liquid organic peroxide particles include less than 50 wt %, 40 wt %, 30 wt %, 20 wt %, 10 wt %, 5 wt %, 2 wt %, or 1 wt % ketone peroxides, benzoyl peroxides, lauryl peroxide, t-butyl peroxymalic acid and/or combinations/mixtures thereof.

In some embodiments the liquid organic peroxide is selected from tert-butyl peroxybenzoate, 2,5-bis(tert-butylperoxy)-2,5-dimethylhexane, 1,1-bis(tert-butylperoxy)-3,3,5-trimethylcyclohexane and/or combinations/mixtures thereof, including for example Luperox® P, Luperox® 101, Luperox® 231 and/or combinations/mixtures thereof available from Arkema.

As used herein, “liquid” means that a substance is flowable and has a measurable volume, but not shape.

As used herein, “liquid organic peroxides” refer to organic peroxide(s), organic peroxide solution(s) or blend(s) of two or more organic peroxides that is/are liquid at temperatures ranging from 20° C. to 60° C.

As used herein, “polyurea” means a compound/moiety formed from an isocyanate reacting with an amine or an amine-containing reactant. Preferably, the amine is a single amine or mixture of two or more different amines or amine-containing reactants. Each amine may be unfunctionalized, monofunctionalized, difunctionalized or multi-functionalized. In some embodiments, two amines allows for flexibility in the amount of crosslinking in the wall.

Without intending to be bound to any theory, the polyurea shell of the encapsulated liquid organic peroxide particles may be formed from the interfacial polymerization between an amine and the at least one isocyanate. According to particular embodiments, the process occurs as a “single encapsulation” in which the organic peroxide and other optional ingredients are contained within a single polyurea shell. Alternatively, the product can be the result of successive encapsulations in which a multi-layer shell particle may be formed.

Amines and amine containing reactants can be either aliphatic or aromatic, with primary and/or secondary amine functionality. Examples of suitable amines include one, two or more of the following: diethylene triamine (DETA), ethylene diamine (EDA), diethyl-toluenediamine, dimethylthio-toluenediamine, NN′-di(secbutyl)-amino-biphenyl methane or combinations thereof. In a preferred embodiment, the amine is a single amine or a mixture of two or more amines.

In some embodiments, the amine is diethylene triamine (DETA) or ethylene diamine (EDA) or a mixture of DETA and EDA.

The mixture of amines can comprise at least two different amines in a 50/50 molar ratio, a 40/60 molar ratio, a 30/70 molar ratio, a 20/80 molar ratio, a 10/90 molar ratio, a 60/40 molar ratio, a 70/30 molar ratio, a 80/20 molar ratio, a 90/10 molar ratio or any molar ratio between 10/90 and 90/10.

In some embodiments, the amine comprises a mixture of DETA and EDA in a 50/50 molar ratio, a 40/60 molar ratio, a 30/70 molar ratio, a 20/80 molar ratio, a 10/90 molar ratio, a 60/40 molar ratio, a 70/30 molar ratio, a 80/20 molar ratio, a 90/10 molar ratio or any molar ratio between 10/90 and 90/10. Increasing the amount of amine, such as for example DETA, may increase the amount of crosslinking. By fine-tuning the level of crosslinking, one can optimize shell mechanical properties, including for example, providing control over the release characteristics of the encapsulated liquid organic peroxide.

Isocyanates can be chosen from aliphatic, cyclic, and/or aromatic classes, and combinations/mixtures thereof, depending on solubility in the organic phase. Preferably the isocyanate is compatible/suitable in the liquid phase. Suitable isocyanates include hexamethylene diisocyanate (HDI), isophorone diisocyanate (IPDI), methylene dicyclohexyl diisocyanate, hydrogenated MDI, and/or combinations thereof. In some embodiments, the polyurea shell can be formed from at least one isocyanate selected from methylene diphenyl diisocyanate (MDI), poly(hexamethylene diisocyanate) (HMDI), isophorone diisocyanate (IPDI), and/or combinations thereof. Suitable isocyanates may also be bio-based isocyanates and/or isocyanates with high renewable content, including for example, ethyl ester L-lysine diisocyanate (LLDI and ethyl ester I-lysine triisocyanate (LLTI) and the like.

In some embodiments, at least one isocyanate is dispersed in the organic phase solution comprising the liquid organic peroxide. Preferably, the isocyanate is soluble to the extent that the isocyanate is substantially or completely dissolved in the organic peroxide(s) before the encapsulation process begins. In some embodiments, the at least one isocyanate has a solubility from about 0.08 wt % to 100 wt %, or preferably from about 20 wt % to 100 wt %, or more preferably from about 50 wt % to about 100 wt %, or from about 60 wt % to about 100 wt %, or from about 70 wt % to about 100 wt %, in the liquid organic peroxide phase solution.

In some embodiments, the encapsulated liquid organic peroxide particles have a wall thickness from about 0.1 to about 50%, from about 1 to about 20%, or from about 2 to about 10% based on the amounts of amines and isocyanates relative to the organic peroxide loadings. In other embodiments, the encapsulated liquid organic peroxide particles have a wall thickness greater than about 50% based on the amounts of amines and isocyanates relative to the organic peroxide loadings. The wall thickness correlates to the ratio of the weight of amines and isocyanates to the total weight of amines, isocyanates and peroxides, assuming 100% crosslinking in the isocyanate for the calculations. Table 1 provides an example formulation in order to prepare a 5% wall thickness encapsulation of Luperox® P.

TABLE 1
Example formulation for preparing encapsulated
Luperox ® P (5% wall thickness)

| | |
|---|---|
| Chemical Name | Weight |

Water phase (80 wt %):

| | |
|---|---|
| PVA (4 g/L) in water | 386 g |
| Water allocated to dilute amines | 34.7 g |
| Oil phase (20 wt %): | |
| Diethylene triamine (DETA) | 3.23 g |
| Ethylene diamine (EDA) | 1.91 g |
| Luperox ® P | 100 g |
| Rubinate M (isocyanate) | 4.24 g |

For emulsion - xanthan gum & biocide loadings (based on total wt %)

| | |
|---|---|
| Proxel GXL (biocide) - 0.2 wt % | 1.06 g |
| Kelzan S Plus (xanthan gum) - 0.2 wt % | 1.06 g |

The following demonstrates formulas useful for calculation of the wall thickness for the formulation set forth in Table 1:

$$\% wall = \frac{weight amines + weight isocyanate}{total weight + peroxides}$$

$$Total weight = \frac{\frac{MW of DETA ( 103.17 g )}{3 ( functionality )} + \frac{MW of EDA ( 60.1 g )}{2 ( functionality )}}{2 ( 50 / 50 ratio )} + MW of isocyanate$$

Excess amine, such as for example, 1 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, up to 100 wt % extra, can be added to the amine mixture compared to the theoretical ratio of amine and isocyanate to improve the reaction rate and encapsulate formation.

The encapsulated liquid organic peroxide particles in the emulsion can possess an average particle size from about 1 to about 150 μm, or about 5 to about 100 μm, or about 10 to about 50 μm, determined using a Malvern Mastersizer 3000E Particle Size Analyzer (laser light scattering).

In some embodiments, the encapsulated liquid organic peroxide particles comprise from about 60 wt % to about 95 wt %, preferably about 70 wt % to about 95 wt %, more preferably about 80 wt % to about 95 wt %, or most preferably about 90 wt % to about 95, or more wt % of the liquid organic peroxide.

In some embodiments, the encapsulated liquid organic peroxide particles are in an emulsion. In some embodiments, the encapsulated liquid organic peroxide particles are a solid, preferably a powder, and optionally comprise at least one or more drying agents. Examples of drying agents include silica, calcium chloride (CaCl2)), sodium sulfate (Na2SO4), calcium sulfate ((CaSO4), also known as Drierite) and/or magnesium sulfate (MgSO4), with silica preferred. In some embodiments, the encapsulated liquid organic peroxide particles comprise one or more additives selected from drying agents, silica, xanthan gum, biocides, preservatives, processing oils, process aids, pigments, dyes, tackifiers, waxes, reinforcing aids, UV stabilization agents, stabilizers, blowing agents, scorch protectors, activators, antiozonants and coagents.

Another aspect of the present disclosure relates to methods for producing the encapsulated liquid peroxide particles via polymerization, comprising the steps of:
preparing an organic phase solution comprising at least one isocyanate dispersed in a liquid organic peroxide,
preparing a water phase solution comprising at least one surfactant,
mixing the organic phase solution with the water phase solution to form an emulsion,
adding an aqueous solution comprising at least one amine to the emulsion,
mixing the aqueous solution and the emulsion for a period of time until a solution comprising encapsulated liquid peroxide particles are produced,
isolating and optionally drying the encapsulated liquid peroxide particles to provide solid particles. An embodiment of this process is depicted the FIGURE.

In some embodiments, the water phase solution comprises one or more surfactants. The surfactant may be any surface-active agent or combination of surface-active agents capable of imparting the desired degree of stability and particle size distribution to the emulsion. Suitable surfactants include those selected from the group consisting of anionic surfactants, nonionic surfactants, amphoteric surfactants, polymeric surfactants, and combinations thereof. Examples of anionic surfactants include ammonium lauryl sulfate, sodium lauryl sarcosinate, sodium stearate, sodium lauryl sulfate, and ammonium laureth sulfate. Examples of nonionic surfactants include ethoxylated alcohol, ethoxylated and alkoxylated fatty acid. Examples of amphoteric surfactants include alkylamidopropylamine N-oxide, alkyldimethylamine N-oxide, alkylbetaine and alkylamidopropylbetaine. Examples of polymeric surfactants include 2-acrylamide-2-methyl-1-propanesulfonic acid and alkyl methacrylamide, alkyl methacrylate or alkyl acrylate, polyvinylpyrrolidone, and polyvinyl alcohol.

In some embodiments, the at least one surfactant is selected from polyvinylpyrrolidone, polyvinyl alcohol and combinations thereof.

In other embodiments, the at least one surfactant is added to the water phase. The surfactant or combination of surfactants may be added until a concentration of 1 g/L to 15 g/L, or 3 g/L to 12 g/L or 5 g/L to 10 g/L is achieved.

In some embodiments, the aqueous solution comprising amine is produced during the preparation of the organic and water phase solutions. Without being bound to any particular theory, it is believed that pre-mixing the amine in an aqueous solution before introduction into the emulsion allows for the removal of potential exotherms that may negatively impact the encapsulation process or the thermal stability of the organic peroxide.

In some embodiments, the amine is a mixture comprised of two or more different amines. In these mixtures, the two different amines can be in a 50/50 molar ratio, a 40/60 molar ratio, a 30/70 molar ratio, a 20/80 molar ratio, a 10/90 molar ratio, a 60/40 molar ratio, a 70/30 molar ratio, a 80/20 molar ratio, a 90/10 molar ratio or any molar ratio between 10/90 and 90/10. In some embodiments, the two different amines are DETA and EDA.

In some embodiments, the at least one isocyanate can be selected from hexamethylene diisocyanate (HDI), isophorone diisocyanate (IPDI), methylene dicyclohexyl diisocyanate, hydrogenated MDI, and combinations thereof. Isocyanates also can be selected from wo bio-based isocyanates including for example ethyl ester L-lysine diisocyanate (LLDI] and ethyl ester l-lysine triisocyanate (LLTI) and the like.

In other embodiments, preparing the organic phase solution further comprises mixing the at least one isocyanate and the liquid organic peroxide for 1 minute to 1 hour or from 5 minutes to 40 minutes, or for a predetermined period of time.

In some embodiments, the organic phase and the water phase are mixed in a batch or continuous process to form an emulsion. In some embodiments, the organic phase and the water phase are mixed in a continuous or batch process from 1 second to 10 minutes, preferably from 5 seconds to 5 minutes, or more preferably mixed from 10 second to 3 minutes, to form an emulsion.

In other embodiments, the aqueous solution and the emulsion are mixed for 5 minutes to 5 hours, or from 10 minutes to 4.5 hours, or from 30 minutes to 4 hours, or from 30 minutes to 3 hours, or from 1 hour to 3 hours, or for a predetermined time based on pH monitoring, to produce the encapsulated liquid peroxide particles.

In some embodiments, the pH of the aqueous solution (i.e., the emulsion mixture) is monitored to determine when the reaction and mixing should stop. The chemical reaction taking place in the emulsion mixture can be stopped by adding an acid (e.g., hydrochloric acid) to the mixture. The reaction will stop when the amines in the mixtures are neutralized by the acid to a pH of about 7.

The encapsulated liquid organic peroxide particles can be used either as an emulsion or as a solid powder in various applications. Suitable additional additives to the encapsulated liquid peroxide particles include surfactants, carriers, bleach activators, builders, abrasives, pigments, rheology control agents, gelling agents, fragrances, anti-deposition agents, enzymes and the like.

If the encapsulated liquid organic peroxide particles are to be used as an emulsion in later applications, then various additives including but not limited to xanthan gum and biocides may be incorporated into the resulting aqueous solution and emulsion mixture to improve its long-term physical stability and other properties.

If the encapsulated liquid peroxide particles are to be used as a powder, then the particles are isolated from the resulting aqueous solution and emulsion mixture via a phase separation process, wherein the encapsulated organic phase is recovered and the aqueous phase is removed. The encapsulated liquid organic peroxide particles may be further subject to treatment such that the encapsulated liquid peroxide particles comprise less than 10% water and/or organic solvents, or less than 5% water and/or organic solvents, less than 2% water and/or organic solvents, or less than 1% water and/or organic solvents.

To further improve the separation and drying process, additives such as silica (e.g., Hi-SIL 233), xanthan gum, and/or biocide can be incorporated into the isolated encapsulated organic phase.

The encapsulated liquid organic peroxide particles can be employed as curing powders, polymer modifiers, crosslinking agents, composite initiators, and in 3D printing ink applications.

Another embodiment of the invention is directed to a masterbatch or ready to cure composition comprising at least one encapsulated organic peroxide as described herein and at least one elastomer to produce a peroxide-elastomer composition. The at least one elastomer may be selected from the group consisting of silicone, EPDM, polyethylene, chlorinated polyethylene and fluoroelastomers. Peroxide-elastomer compositions of the invention may be produced by mixing at least one encapsulated peroxide into at least one elastomer. The peroxide-elastomer compositions of the invention may be then cured to form articles such as a hose, gasket, seal, wire and cable, O-ring, vibration damper and/or crosslinked films.

### ASPECTS OF THE INVENTION

Aspect 1. An encapsulated liquid organic peroxide particle comprising:
a liquid organic peroxide encapsulated by a polyurea shell, wherein the liquid organic peroxide contributes from about 60 wt % to about 95 wt % towards the overall weight of the encapsulated liquid organic peroxide particle;
   and optionally a drying agent.
Aspect 2. The encapsulated liquid organic peroxide particle according to Aspect 1, wherein the liquid organic peroxide is selected from the group consisting of diacyl peroxides, diakyl peroxides, peroxyketal peroxides, peroxydicarbonate peroxides, peroxyesters, monoperoxycarbonate peroxides, hydroperoxides, and mixtures thereof.
Aspect 3. The encapsulated liquid organic peroxide particle according to any of Aspect 1 or Aspect 2, wherein the liquid organic peroxide is selected from the group consisting of t-butyl peroxybenzoate, 2,5-dimethyl-2,5-di(tert-butylperoxy) hexane, 1,1 bis(t-butylperoxy) 3,3,5 trimethylcyclohexane, 1,1-di(t-butylperoxy)-cyclohexane, OO-(t-butyl) O-(2-ethylhexyl) monoperoxycarbonate and mixtures thereof.
Aspect 4. The encapsulated liquid organic peroxide particle according to any of Aspects 1-3 wherein the polyurea shell is formed from polymerization of an amine, an amine mixture, or an amine-containing reactant and a liquid organic solution comprising at least one isocyanate, preferably wherein the at least one isocyanate is selected from the group consisting aliphatic, cyclic, and/or aromatic isocyanates and combinations thereof, more preferably is at least one isocyanate selected from the group consisting of hexamethylene diisocyanate (HDI), isophorone diisocyanate (IPDI), methylene dicyclohexyl diisocyanate, hydrogenated MDI, and combinations thereof.
Aspect 5. The encapsulated liquid organic peroxide particle according to Aspect 4, wherein the amine mixture comprises two or more amines or amine-containing reactants, preferably diethylene triamine (DETA) and ethylene diamine (EDA), more preferably DETA and EDA in a molar ratio of from 10/90 to 90/10.
Aspect 6. The encapsulated liquid organic peroxide particle according to Aspect 4, wherein the at least one isocyanate has a solubility from about 0.08 wt % to 100 wt %, preferably from 20 wt % to 100 wt %, more preferably from 50 wt % to 100 wt % in the liquid organic solution.
Aspect 7. The encapsulated liquid organic peroxide particle according to any of Aspects 4-6, wherein the polyurea shell possesses a thickness ranging from about 0.1 to 50% based on an amount of amine and isocyanate relative to the total amount of amines, isocyanates, and organic liquid peroxide.
Aspect 8. The encapsulated liquid organic peroxide particle according to any of Aspects 1-7, wherein the encapsulated liquid organic peroxide particle has a particle size ranging from about 1 to 150 μm.
Aspect 9. The encapsulated liquid organic peroxide particle according to any of Aspects 1-8, wherein the liquid organic peroxide contributes from about 70 wt % to about 95 wt %, preferably from about 80 wt % to about 95 wt %, more preferably from about 90 wt % to 95 wt %, towards a total weight of the encapsulated liquid organic peroxide particle.
Aspect 10. The encapsulated liquid organic peroxide particle according to any of Aspects 1-9, wherein the encapsulated liquid organic peroxide particle is a solid, preferably a powder, and optionally comprises one or more of a drying agent, preferably silica, xanthan gum, biocide, and additives.
Aspect 11. An encapsulated liquid organic peroxide particle comprising a liquid organic peroxide encapsulated by a polyurea shell, wherein the polyurea shell is formed by polymerization between a preformed aqueous amine solution and an organic solution comprising at least one isocyanate.
Aspect 12. A method for producing encapsulated liquid peroxide particles via polymerization comprising the steps of:
   preparing an organic phase solution comprising at least one isocyanate dispersed in a liquid organic peroxide,
   preparing a water phase solution comprising at least one surfactant,
   mixing the organic phase solution with the water phase solution to form an emulsion,
   adding an aqueous solution comprising at least one amine to the emulsion,
   mixing the aqueous solution and the emulsion for a period of time until a solution comprising encapsulated liquid peroxide particles is produced, and
   isolating, and optionally drying the encapsulated liquid peroxide particles.
Aspect 13. The method of Aspect 12, wherein the at least one surfactant is selected from polyvinylpyrrolidone, polyvinyl alcohol and combinations thereof and the aqueous amine solution comprises a mixture of at least two different amines.
Aspect 14. The method of Aspect 12, wherein the encapsulated liquid peroxide particles are isolated from the solution comprising said particles via a phase separation process, wherein the phase separation process recovers an organic phase comprising the encapsulated liquid peroxide particles.
Aspect 15. The method of Aspect 12, wherein the liquid organic peroxide is one or more liquid organic peroxides selected from the group consisting of diacyl peroxides, dialkyl peroxides, peroxyketal peroxides, peroxydicarbonate peroxides, monoperoxycarbonate peroxides, peroxyesters, hydroperoxides, tert-butyl peroxybenzoate, 2,5-dimethyl, 2,5-di(tert-butylperoxy) hexane, 1,1-Bis(tert-butylperoxy)-3,3,5-trimethylcyclohexane, 1,1-di(tert-butylperoxy)cyclohexane, OO-(t-butyl) O-(2-ethylhexyl) monoperoxycarbonate, and combinations thereof.
Aspect 16. The method of Aspect 12, wherein the amine is diethylene triamine (DETA), ethylene diamine (EDA), or a combination thereof, preferably wherein DETA and EDA are in a molar ratio of from 10/90 to 90/10 in a mixture of said amines.
Aspect 17. The method of Aspect 12, wherein the at least one isocyanate is selected from aliphatic isocyanates, cyclic isocyanates, aromatic isocyanates, methylene diphenyl diisocyanate (MDI), poly(hexamethylene diisocyanate) (HMDI) and combinations thereof.
Aspect 18. The encapsulated liquid organic peroxide particle according to any of Aspects 1-11, wherein the encapsulated liquid organic peroxide particle is a solid containing less than 10% water and/or organic solvents, preferably less than 5% water and/or organic solvents, and more preferably less than 2% water and/or organic solvents, based on the total weight of the encapsulated organic peroxide particle.
Aspect 19. An emulsion comprising the encapsulated liquid organic peroxide particles according to any of Aspects 1-11.
Aspect 20. A master batch or ready to cure composition comprising at least one encapsulated organic peroxide according to any of Aspects 1-11 and at least one elastomer.
Aspect 21. The masterbatch or ready to cure composition of Aspect 20 wherein the at least one elastomer is at least one of silicone, EPDM, polyethylene, chlorinated polyethylene and fluoroelastomers.
Aspect 22. A composition comprising at least one encapsulated organic peroxide according to any of Aspects 1-11, at least one liquid polyester resin, and optionally fillers and/or fiber reinforcement.
Aspect 23. The composition of Aspect 22 which is cured to form a crosslinked composite using pultrusion, compression molding, bulk molding and/or potting.

### EXAMPLES

### Example 1: Microencapsulation of Luperox® P

100 g of Luperox® P was mixed with 4.24 g of Huntsman® Rubinate M isocyanate. The mixture of organic peroxide and isocyanate was then added to 386 g of a 4 g/L Polyvinyl alcohol (PVA) in water solution. The combined solutions were emulsified using a rotor-static device. A mixture of 3.23 g of diethylene triamine (DETA) and 1.91 g of ethylene diamine (EDA) was diluted in 34.7 g of water. Once a stable emulsion was obtained, the amines diluted in water were added to the emulsion and stirred at room temperature for 1 hour. The final solution was allowed to phase separate, and the organic phase was isolated, dried at room temperature, and sieved with Hi-SIL 233 silica to produce a yellow-tinted powder of the Luperox® P encapsulated within a crosslinked polyurea shell. The particle size range was measured to be between 10 and 30 microns.

### Example 2: Microencapsulation of Luperox®101

100 g of Luperox®101 was mixed with 4.84 g of poly(hexamethylene diisocyanate). The mixture of organic peroxide and isocyanate was then added to 470 g of a 4 g/L PVA in water solution. The combined solutions were emulsified using a rotor-static device. A mixture of 2.52 g of diethylene triamine (DETA) and 1.47 g of ethylene diamine (EDA) were placed in 26.6 g of water. Once a stable emulsion was obtained, the amines diluted in water were added to the emulsion and stirred at room temperature for 3 hours. The final solution was allowed to phase separate, and the encapsulated organic phase was isolated, dried at room temperature, and sieved with Hi-SIL 233 silica to produce a yellow-tinted powder of the Luperox®101 encapsulated within a crosslinked polyurea wall. The particle size ranged from 10 to 50 microns.

### Example 3: Microencapsulation of Luperox®231

150 g of Luperox®101 was mixed with 3.78 g of poly(hexamethylene diisocyanate). The mixture of organic peroxide and isocyanate was then added to 428 g of a 4 g/L PVA in water solution. The combined solutions were emulsified using a rotor-static device. A mixture of 3.78 g of diethylene triamine (DETA) and 2.2 g of ethylene diamine (EDA) was placed in 40 g of water. Once a stable emulsion was obtained, the amines diluted in water were added to the emulsion and stirred at room temperature for 3 hours. The final solution was allowed to phase separate, and the encapsulated organic phase was isolated, dried at room temperature, and sieved with Hi-SIL 233 silica to produce a yellow-tinted powder of the Luperox®231 encapsulated within a crosslinked polyurea wall. The particle size ranged from 30 to 100 microns.

### Example 4: Extraction by Solvents for Determining Amount of Encapsulated Liquid Organic Peroxide

About 100 mg of encapsulated powders with either 5% or 20% wall thickness containing Luperox® P was placed in a 25 ml volumetric flask and an extraction solvent (methanol, isopropanol, or acetonitrile) was added. The samples were saturated in the extraction solvent for one hour before aliquots were analyzed by HPLC. The solvent role was to permeate/swell the polymer shells of encapsulated powders, thus allowing Luperox® P to leach into the solvent. In order to test the extraction efficiency of different solvents, these analyses were done in triplicate using three solvents with different dielectric constants. The extraction results are summarized in Table 2 below.

TABLE 2
HPLC analyses of 5% and 20% wall thickness
encapsulated Luperox ®P samples

| Extraction | Dielectric | Wt % Luperox ®P: | Wt % Luperox ®P: |
|---|---|---|---|
| Solvent | Constant | 5% wall thickness | 20% wall thickness |
| Methanol | 32.7 | 92% | 71% |
| Isopropanol* | 19.9 | 73% | 58% |
| Acetonitrile | 37.5 | 93% | 68% |

It appears that the extraction power of isopropanol (IPA) is not as good as methanol or acetonitrile. These extraction results demonstrate that the interfacial polymerization method used to create the encapsulated powders can successfully encapsulate a large amount of liquid peroxide (up to 93 wt %).

### Example 5: Curing of Dow Silastic™ TR-55 Silicone Rubber with Luperox® P XL50 and Encapsulated Luperox® P

Materials: Luperox® P is a tert-butyl peroxybenzoate, which is an organic peroxide manufactured by Arkema Inc. Dow Silastic™ TR-55 silicone rubber is a VMQ type of silicone rubber. VMQ is the ASTM designation for a vinyl methyl silicone rubber that is peroxide cured.

Preparation of a sample of the unencapsulated powder form of Luperox® P XL50 from the liquid peroxide was done by adding or absorbing the peroxide on a silica filler:
5.00 grams Luperox® P (99% assay) liquid peroxide
4.90 grams Hi-Sil 233 silica from PPG
9.90 grams Luperox® P XL50 (50% assay) free-flowing powder peroxide was made.

Using a C. W. Brabender mixer equipped with sigma blades with no heat (room temperature mixing), 50 grams of silicone rubber was added to the mixing chamber with a mixing speed of 25 rpm followed by the solid form of the various organic peroxides, which were weighed using a Mettler Analytical Balance. The rubber was mixed for three minutes, removed from the bowl, and remixed another three minutes. The uncured rubber was then carefully cold pressed into a sheet, using no heat to about 3/16 inches (4.8 mm) thick. The uncured silicone rubber sheet was then placed on aluminum foil (uncovered) and stored on the laboratory benchtop. Samples from this rubber sheet were used for a cure study versus days of aging of the uncured rubber sheet on the bench top. A loss of cure would correspond to a loss of peroxide by evaporation.

The following amounts of rubber and peroxide were weighed to create silicone rubber samples containing various peroxides for testing on the RPA® 2000 Rheometer from Alpha Technologies.

### Preparation of a Sample of Silicone Rubber Containing Unencapsulated Luperox® P XL50:

50.00 grams Silastic™ TR-55
0.2500 grams Luperox® P XL50

### Preparation of a Sample of Silicone Rubber Containing Encapsulated Luperox® P, 20% Wall Thickness:

50.00 grams Silastic™ TR-55
0.5000 grams 20% wall thickness (encapsulated Luperox® P)

### Preparation of a Sample of Silicone Rubber Containing Encapsulated Luperox® P, 5% Wall Thickness:

50.00 grams Silastic™ TR-55
0.5000 grams 5% wall thickness (encapsulated Luperox® P)

Samples of the uncured rubber sheet weighing 5 grams were taken over time and tested on a RPA® 2000 Rheometer from Alpha Technologies. The rubber was placed between two sheets of Dartek® film provided by Alpha Technologies to study the relative degree of crosslinking. The RPA® 2000 testing conditions used were 170° C. temperature for the upper and lower dies, 100 cpm frequency, a 1° arc applied strain and a 15-minute testing time.
MH=maximum torque in dN-m
ML=minimum torque in dN-m
MH−ML is the delta torque in dN-m, and is defined as the Relative Degree of Crosslinking.

MH−ML (dN-m) is the delta torque value obtained from the RPA® 2000 Rheometer manufactured by Alpha Technologies that provides information about the relative degree of crosslinking. The higher the MH-ML delta torque value in dN-m, the higher the amount of relative degree of crosslinking obtained.

The relative degree of crosslinking in dNm torque was studied over time for the uncured rubber sheet that was stored on the benchtop. Using the degree of crosslinking numbers, the percent change in cure (loss in cure) over time was determined. The curing results are reported in Table 3 below.

TABLE 3
Curing Dow Silastic ™ TR-55 silicone rubber with Luperox ®P XL50 and encapsulated Luperox ®P

| MH-ML (dN-m) | | | | | | % Change in MH-ML | | |
|---|---|---|---|---|---|---|---|---|
| Relative Degree of Crosslinking in dNm torque | | | | | | (% Loss of Crosslinking) | | |
| | | Luperox ®P | 20% wall | 5% wall | | Luperox ®P | 20% wall | 5% wall |
| Days | Date | XL50 | thickness | thickness | Date | XL50 | thickness | thickness |
| 0 days | Sep. 3, 2021 | 19.93 | 15.2 | 20.43 | Sep. 3, 2021 | — | — | — |
| 10 days | Sep. 13, 2021 | 18.13 | 13.15 | 20.92 | Sep. 13, 2021 | 9.03% | 13.49% | No change |
| 24 days | Sep. 27, 2021 | 14.39 | 12.16 | 19.7 | Sep. 27, 2021 | 27.80% | 20.00% | 3.57% |

In summary, the 5% wall thickness encapsulated Luperox® P peroxide when compounded into silicone rubber and allowed to age for 24 days uncovered on a benchtop unexpectedly provided an excellent relative degree of crosslinking at 170° C. of 19.7 dNm, with only a 3.57% minor change in crosslinking compared to 0 (zero) day crosslinking value of 20.43 dNm. Essentially there was no loss in crosslinking after 24 days of the rubber compound that was allowed to age at room temperature on a benchtop uncovered. Thus the novel encapsulation of the peroxide unexpectedly prevented undesirable evaporation (loss) of peroxide from the silicone elastomer compound over time.

In contrast the standard uncapsulated Luperox® P XL50 peroxide in the same silicone rubber exhibited a significant 27.8% loss in cure after 24 days wherein the relative degree of crosslinking dropped from 19.93 dNm to 14.39 dNm.

The 5% wall thickness encapsulated peroxide thus provided an unexpected retention of the crosslinking over time that was better than the other peroxide samples tested. The 20% wall thickness encapsulated peroxide created a visually darker cured silicone rubber RPA disk. The 5% wall thickness encapsulated Luperox® P created a cured silicone rubber disk that appeared similar to the cured product obtained with the standard unencapsulated Luperox® PXL50 peroxide. That silicone rubber was translucent and unfilled. However color from the use of a thicker encapsulation would not be a concern when using a mineral filled or carbon black filled elastomer when using a 20% wall thickness encapsulated peroxide that still unexpectedly provided better results versus the unencapsulated standard Luperox® PXL50 peroxide.

Although embodiments have been described in terms of specific exemplary embodiments and examples, the embodiments disclosed herein are for illustrative purposes only and various modifications and alterations might be made by those skilled in the art without departing from the spirit and scope of the invention as set forth in the following claims.

### PROPHETIC EXAMPLE

### Prophetic Example 6: Curing Polyester Resin with Unencapsulated Standard Liquid Luperox® P and the Novel Solid Powder Form of an Encapsulated 5% Wall Luperox® P

Luperox® P is a tert-butyl peroxybenzoate, which is a standard unencapsulated liquid organic peroxide manufactured by Arkema Inc. Using the teachings of this invention to encapsulate a liquid peroxide and the equations below to calculate % wall thickness in this invention a novel 5% wall thickness encapsulated Luperox® P solid powdered sample is prepared using standard liquid Luperox® P peroxide.

$$\% wall = \frac{weight amines + weight isocyanate}{total weight + peroxides}$$

$$Total weight = \frac{\frac{MW of DETA ( 103.17 g )}{3 ( functionality )} + \frac{MW of EDA ( 60.1 g )}{2 ( functionality )}}{2 ( 50 / 50 ratio )} + MW of isocyanate$$

Liquid Luperox® P (98% assay) is compared to 5% wall thickness solid powder encapsulated Luperox® P (25% assay) for curing a polyester resin. The two peroxides are added at amounts to provide equivalent amount of peroxide based on % assay in a polyester resin. Thus 2 phr of liquid Luperox® P (98% assay) is compared to 7.84 phr 5% wall solid encapsulated Luperox® P (25% assay) in a standard polyester resin which are then cured at 80° C. using the standard composite gel test procedure (ASTM D2471). Table 4 shows the peak exotherm time for polyester resin samples prepared with both neat unencapsulated Luperox® P and solid encapsulated Luperox® P. Surprisingly, the solid encapsulated Luperox® P cures the polyester resin before the liquid, unencapsulated Luperox® P peroxide. This suggests that the novel polyurea encapsulating shell can both protect the organic peroxide at standard storage and standard handling temperatures and then quite unexpectedly accelerate cure of a polyester resin at elevated cure temperatures. The shorter time to peak exotherm indicates a faster rate of cure.

Prophetic Table 4. Curing Polyester Resin with
the novel 5% wall encapsulated Luperox ® P
vs standard liquid Luperox ® P

| | Time to Peak |
|---|---|
| Organic Peroxide Type | Exotherm in Minutes |
| Novel Encapsulated Solid 5% wall Luperox ® P | 85 minutes |
| Standard Liquid Luperox ® P | 130 minutes |

1. An encapsulated liquid organic peroxide particle comprising:
a liquid organic peroxide encapsulated by a polyurea shell, wherein the liquid organic peroxide contributes from about 60 wt % to about 95 wt % towards the overall weight of the encapsulated liquid organic peroxide particle;
and optionally a drying agent.

2. The encapsulated liquid organic peroxide particle according to claim 1, wherein the liquid organic peroxide is selected from the group consisting of diacyl peroxides, diakyl peroxides, peroxyketal peroxides, peroxydicarbonate peroxides, peroxyesters, monoperoxycarbonate peroxides, hydroperoxides, and mixtures thereof.

3. The encapsulated liquid organic peroxide particle according to claim 1, wherein the liquid organic peroxide is selected from the group consisting of t-butyl peroxybenzoate, 2,5-dimethyl-2,5-di(tert-butylperoxy) hexane, 1,1 bis(t-butylperoxy) 3,3,5 trimethylcyclohexane, 1,1-di(t-butylperoxy)-cyclohexane, OO-(t-butyl) 0-(2-ethylhexyl) monoperoxycarbonate and mixtures thereof.

4. The encapsulated liquid organic peroxide particle according to claim 1, wherein the polyurea shell is formed from polymerization of an amine, an amine mixture, or an amine-containing reactant and a liquid organic solution comprising at least one isocyanate.

5. The encapsulated liquid organic peroxide particle according to claim 4, wherein the amine mixture comprises two or more amines or amine-containing reactants.

6. The encapsulated liquid organic peroxide particle according to claim 4, wherein the at least one isocyanate has a solubility from about 0.08 wt % to 100 wt % in the liquid organic solution.

7. The encapsulated liquid organic peroxide particle according to claim 4, wherein the polyurea shell possesses a thickness ranging from about 0.1 to 50% based on an amount of amine and isocyanate relative to the total amount of amines, isocyanates, and organic liquid peroxide.

8. The encapsulated liquid organic peroxide particle according to claim 1, wherein the encapsulated liquid organic peroxide particle has a particle size ranging from about 1 to 150 μm.

9. The encapsulated liquid organic peroxide particle according to claim 1, wherein the liquid organic peroxide contributes from about 70 wt % to about 95 wt % towards a total weight of the encapsulated liquid organic peroxide particle.

10. The encapsulated liquid organic peroxide particle according to claim 1, wherein the encapsulated liquid organic peroxide particle is a solid, and optionally comprises one or more of a drying agent, xanthan gum, biocide, and additives.

11. An encapsulated liquid organic peroxide particle comprising a liquid organic peroxide encapsulated by a polyurea shell, wherein the polyurea shell is formed by polymerization between a preformed aqueous amine solution and an organic solution comprising at least one isocyanate.

12. A method for producing encapsulated liquid peroxide particles via polymerization comprising the steps of:
preparing an organic phase solution comprising at least one isocyanate dispersed in a liquid organic peroxide,
preparing a water phase solution comprising at least one surfactant,
mixing the organic phase solution with the water phase solution to form an emulsion,
adding an aqueous solution comprising at least one amine to the emulsion,
mixing the aqueous solution and the emulsion for a period of time until a solution comprising encapsulated liquid peroxide particles is produced, and
isolating, and optionally drying the encapsulated liquid peroxide particles.

13. The method of claim 12, wherein the at least one surfactant is selected from polyvinylpyrrolidone, polyvinyl alcohol and combinations thereof and the aqueous amine solution comprises a mixture of at least two different amines.

14. The method of claim 12, wherein the encapsulated liquid peroxide particles are isolated from the solution comprising said particles via a phase separation process, whereby the phase separation process recovers an organic phase comprising the encapsulated liquid peroxide particles.

15. The method of claim 12, wherein the liquid organic peroxide is one or more liquid organic peroxides selected from the group consisting of diacyl peroxides, dialkyl peroxides, peroxyketal peroxides, peroxydicarbonate peroxides, monoperoxycarbonate peroxides, peroxyesters, hydroperoxides, tert-butyl peroxybenzoate, 2,5-dimethyl, 2,5-di(tert-butylperoxy) hexane, 1,1-Bis(tert-butylperoxy)-3,3,5-trimethylcyclohexane, 1,1-di(tert-butylperoxy)cyclohexane, OO-(t-butyl)O-(2-ethylhexyl) monoperoxycarbonate, and combinations thereof.

16. The method of claim 12, wherein the amine is diethylene triamine (DETA), ethylene diamine (EDA), or a combination thereof in a molar ratio of from 10/90 to 90/10.

17. The method of claim 12, wherein the at least one isocyanate is selected from aliphatic isocyanates, cyclic isocyanates, aromatic isocyanates, methylene diphenyl diisocyanate (MDI), poly(hexamethylene diisocyanate) (HMDI) and combinations thereof.

18. The encapsulated liquid organic peroxide particle according to claim 1, wherein the encapsulated liquid organic peroxide particle is a solid containing less than 10% water and/or organic solvents, based on the total weight of the encapsulated organic peroxide particle.

19. An emulsion comprising the encapsulated liquid organic peroxide particles according to claim 1.

20. A master batch or ready to cure composition comprising the at least one encapsulated organic peroxide particle according to claim 1 and at least one elastomer.

21. The masterbatch or ready to cure composition of claim 20, wherein the at least one elastomer is at least one of silicone, EPDM, polyethylene, chlorinated polyethylene and fluoroelastomers.

22. A composition comprising at least one encapsulated organic peroxide according to claim 1, at least one liquid polyester resin, and optionally fillers and/or fiber reinforcement.

23. The composition of claim 22 which is cured to form a crosslinked composite using pultrusion, compression molding, bulk molding and/or potting.

24. The encapsulated liquid organic peroxide particle according to claim 4, wherein the at least one isocyanate is at least one selected from the group consisting of hexamethylene diisocyanate (HDI), isophorone diisocyanate (IPDI), methylene dicyclohexyl diisocyanate, hydrogenated MDI, and combinations thereof.
